(19) United States
(12) Patent Application Publication
(10) Pub. No.: US 2026/0243128 A1
(43) Pub. Date: Aug. 20, 2026

(54) VACUUM INSULATED FENESTRATION ASSEMBLIES AND METHODS

(71) Applicant: Marvin Lumber and Cedar Company, LLC d/b/a Marvin Windows and Doors, Eagan, MN (US)

(72) Inventors: Benjamin Wallace, Minnetonka, MN (US); Stephen Donald Fisher, Warroad, MN (US)

(21) Appl. No.: 19/543,505

(22) Filed: Feb. 18, 2026

Related U.S. Application Data
(60) Provisional application No. 63/759,841, filed on Feb. 18, 2025.

(51) Int. Cl. E06B 3/70

(52) U.S. Cl. CPC E06B 3/7015

(57) ABSTRACT

Systems and techniques for vacuum-insulated fenestration assemblies are described herein. In examples, a door frame is configured for installation within a building. A door panel is coupled within the door frame. The door panel includes a front face and a rear face, according to some examples. The front and rear faces are oriented in opposite directions. A door recess is between the front face and the rear face. A vacuum-insulated core (VIC) is within the door recess and between the front face and the rear face of the door panel. In examples, the VIC includes a vacuum cavity with a lower-than-ambient-pressure environment. A jacket encloses the vacuum cavity. The VIC also includes an edge seal surrounding the vacuum cavity such that the jacket and the edge seal maintain the lower-than-ambient-pressure environment of the vacuum cavity, according to some examples.

### CLAIM OF PRIORITY

This patent application claims the benefit of priority, under 35 U.S.C. Section 119(e), to Benjamin Wallace, U.S. Patent Application Serial Number 63/759,841, entitled “VACUUM INSULATED FENESTRATION ASSEMBLIES AND METHODS FOR SAME,” filed on February 18, 2025 (Attorney Docket No. 1261.211PRV), which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Lumber and Cedar Company, LLC d/b/a Marvin Windows and Doors of Eagan, Minnesota, USA. All rights reserved.

### TECHNICAL FIELD

Examples described herein generally relate to, but are not limited to, fenestration assemblies and vacuum-insulated fenestration assemblies.

### BACKGROUND

Wood-based exterior doors are employed in the construction industry. These doors are manufactured with various panel configurations, wood species, decorative profiles, and flat or raised panel designs. Exterior doors that provide at least some thermal insulation include steel or fiberglass doors with foam filling. For example, foam blocks, settable foam, or the like may be disposed within the door panel.

### SUMMARY

The present disclosure notes, among other things, that a problem to be solved includes increasing insulation for fenestration assemblies. In some examples, fenestration assemblies are made from materials such as wood, fiberglass, steel, aluminum, or the like. The fenestration assemblies discussed herein include one or more vacuum-insulated cores.

In some examples, wood-based doors are limited in thermal performance due to two factors: the inherent thermal properties of wood and space constraints that limit the inclusion of insulating materials. Wood has a modest R-value of approximately 1.4 per inch, while some foam insulations provide relatively greater R-values of about 4 per inch. In some examples, the thermal performance of wood doors is increased by incorporating foam panel cores or thin layers of foam insulation between split raised panels. The thermal performance (e.g., R-values) of these doors has not achieved levels comparable to those of foam-filled steel and fiberglass doors. However, foam-filled steel and fiberglass doors provide limited customization options despite their higher thermal performance. For example, foam-filled and fiberglass doors (and fenestration assemblies, collectively) are, in many examples, manufactured in pre-determined sizes and configurations that limit customization with different trims, panels, or the like. As discussed herein, wood-based doors include customization options that are desirable but have poor thermal performance. A technical challenge exists in achieving thermal performance comparable to foam-filled doors while retaining the customization capabilities of wood-based doors.

The present disclosure describes example fenestration assemblies having vacuum-insulated cores that address the noted problems while providing performance and aesthetic benefits (e.g., customization). In examples, a wood-based fenestration assembly includes a panel, such as a door panel, with a front face and a rear face facing opposite directions (e.g., interior and exterior). The VIC includes a vacuum cavity and a jacket enclosing the vacuum cavity to provide specified and enhanced thermal performance.

In examples, a fenestration assembly, such as a door assembly, includes a door panel with a front face and a rear face, facing opposite directions (e.g., facing an exterior and facing an interior). In some examples, the front and rear faces include wood, metal, composite (e.g., fiberglass), or the like and are opaque. A vacuum-insulated core (VIC) is disposed between the front face and the rear face of the door panel. The VIC includes a vacuum cavity and a jacket enclosing the vacuum cavity. The front and rear faces extend over the VIC and, in some examples, conceal the VIC to provide the appearance of a solid door assembly.

In another example, a fenestration assembly, such as a door assembly, includes a door panel including a front face, a rear face, and a hollow portion between the front face and the rear face. A method includes inserting the (VIC) within a hollow door recess of the door assembly, for instance between the front and rear faces of the door assembly. The VIC includes a vacuum cavity disposed between a first jacket layer and a second jacket layer. The VIC is inserted within the hollow door recess with the first jacket layer proximate to the front face and the second jacket layer proximate to the rear face. In some examples, sealing the door assembly includes enclosing the VIC within the door panel such that at least a portion of the VIC is concealed from external view.

The above discussion provides an overview of the subject matter of the present patent application. It is not intended to provide an exclusive or exhaustive explanation of the invention. The detailed description is included to provide further information about the present patent application.

### BRIEF DESCRIPTION OF THE DRAWINGS

Various examples are illustrated in the figures of the accompanying drawings. Such examples are demonstrative and not intended to be exhaustive or exclusive examples of the present subject matter.

FIG. 1 is a front view of an example of a door assembly having an example of a vacuum-insulated core.

FIG. 2 illustrates a cross-sectional view of a portion of the door assembly of FIG. 1.

FIG. 3 is a perspective cutaway view of an example vacuum-insulated core.

FIG. 4 is a front view of another example door assembly having one or more vacuum-insulated cores.

FIG. 5 is a cross-sectional view of door interior examples for the door assembly of FIG. 4.

FIG. 6 is a cross-sectional view of door interior examples for the door assembly of FIG. 4.

FIG. 7 is a cross-sectional view of door interior examples for the door assembly of FIG. 4.

FIG. 8 is a cross-sectional view of door interior examples for the door assembly of FIG. 4.

FIG. 9 is a front view of an additional example door assembly having one or more vacuum-insulated cores.

FIG. 10 is a cross-sectional view of door interior examples for the door assembly of FIG. 9.

FIG. 11 is a cross-sectional view of door interior examples for the door assembly of FIG. 9.

FIG. 12 is a cross-sectional view of an additional example of a door interior for the door from FIG. 9.

FIG. 13 is a block diagram of an example method of building a door assembly.

### DETAILED DESCRIPTION

Exterior doors are employed in the construction industry to provide ingress and egress to buildings while separating interior environments from exterior environments. Exterior doors may provide thermal insulation to reduce heat transfer between the interior and exterior environments.

Exterior doors that provide thermal insulation include steel doors and fiberglass doors that have foam cores. Steel and fiberglass doors with foam cores provide thermal insulation that meets or exceeds building code requirements. However, steel and fiberglass doors are manufactured in predetermined sizes and configurations. Steel and fiberglass doors require tooling and capital investment to produce different shapes, profiles, and panel configurations. Steel and fiberglass doors offer limited customization options for trims, panel styles, decorative profiles, and panel designs.

Wood-based exterior doors offer customization options not available with steel or fiberglass doors. Wood-based doors may be manufactured with various panel configurations, wood species, decorative profiles, sticking profiles, flat-panel designs, and raised-panel designs. Wood-based doors do not require the tooling and capital investment associated with shaping steel or fiberglass doors. Wood-based doors can be manufactured to match an architectural style of a building.

However, wood-based doors have limited thermal performance. Wood has a thermal resistance (R-value) of approximately 1.4 per inch. Foam insulation has a thermal resistance of approximately 4 per inch. The space within a wood-based door panel is limited, limiting the thickness of insulating materials that may be included. Wood-based doors that incorporate foam panel cores or thin layers of foam insulation between split raised panels have not achieved thermal performance levels comparable to foam-filled steel and fiberglass doors.

Approaches to increasing the thermal performance of wood-based doors include increasing door thickness to accommodate thicker foam layers. Doors having thicknesses of three to four inches may accommodate thick foam layers to provide thermal insulation. However, increased door thickness affects door weight, hardware compatibility, frame dimensions, and installation requirements. A gap exists between the thermal performance of foam-filled steel and fiberglass doors and the customization capabilities of wood-based doors. Steel and fiberglass doors offer thermal performance but lack customization options. Wood-based doors provide customization but lack thermal performance.

The present disclosure describes fenestration assemblies that have vacuum-insulated cores (VICs) disposed within door panels. The VICs provide thermal insulation within the space constraints of wood-based door panels while preserving customization capabilities. A VIC includes a vacuum cavity enclosed between jacket layers. The vacuum cavity has a lower-than-ambient pressure environment. The lower-than-ambient pressure environment reduces conductive and convective heat transfer through the VIC. The jacket layers maintain the lower-than-ambient pressure environment. The VIC provides thermal resistance with a thickness less than that of foam insulation, providing at least enhanced thermal resistance.

The present disclosure describes door assemblies having a door frame configured for installation within a building and a door panel coupled within the door frame. The door panel includes a front face directed in a first direction and a rear face directed in a second direction different from the first direction. The space between the front and rear faces includes a door recess. A VIC is disposed within the door recess and between the front face and the rear face of the door panel.

The VIC includes a vacuum cavity having a lower-than-ambient pressure environment and a jacket enclosing the vacuum cavity. The jacket includes a first jacket layer disposed within the door panel adjacent to the front face and a second jacket layer disposed within the door panel adjacent to the rear face. An edge seal may extend between the first and second jacket layers. The first jacket layer, the second jacket layer, and the edge seal encompass the vacuum cavity to maintain the lower-than-ambient pressure environment.

The door panel may include wood, metal, fiberglass, or a combination thereof. Wood-based door panels with VICs disposed therein may be manufactured with various panel configurations, wood species, decorative profiles, flat-panel designs, and raised-panel designs. The VIC provides thermal insulation within the door panel without increasing door thickness beyond standard dimensions.

In examples, the VIC extends the length of the door assembly. In examples, the VIC extends at least partially into one or more components of the door panel, including stiles, rails, mullions, or panel portions. In examples, multiple VICs are disposed within the door panel, each VIC corresponding to a different component of the door assembly.

In examples, the door panel includes a window port that is filled by a portion of the VIC. The window port allows light to pass through the door assembly. The portion of the VIC filling the window port may be non-opaque. The remainder of the VIC may be opaque and concealed by both the front and rear faces. In some examples, multiple VICs are layered between the front and rear faces. A first VIC may be disposed adjacent to the front face, and a second VIC may be disposed between the first VIC and the rear face. The layered VIC configuration provides increased thermal insulation.

The present disclosure also describes methods of assembling door assemblies. A method includes positioning a VIC between the front and rear faces of a door panel. The method includes sealing the door assembly to enclose the VIC within the door panel. The method includes coupling the door panel to a fenestration frame.

The fenestration assemblies described herein provide thermal insulation using VICs while preserving the customization capabilities of wood-based door construction. The VICs occupy less space than foam insulation while providing equivalent thermal resistance, allowing insulation to be incorporated within standard door panel dimensions.

The above discussion provides an overview of the subject matter of the present patent application. It is not intended to provide an exclusive or exhaustive explanation of the invention. The description below is included to provide further information about the present patent application.

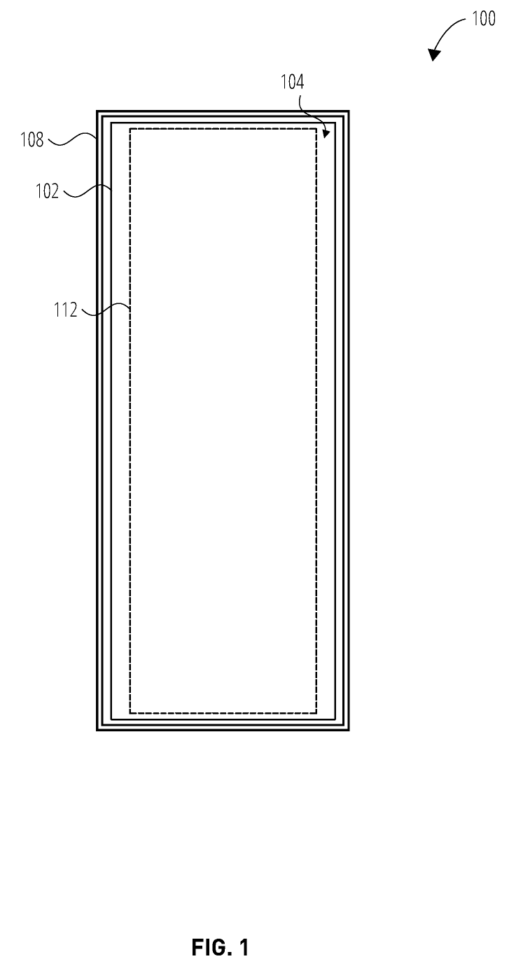

FIG. 1 illustrates a front view of an example door assembly 100 having a vacuum-insulated core, e.g., a VIC 112. The door assembly 100 includes a door frame 108, a door panel 102 (movably) coupled within the door frame 108, a front face 104, and the VIC 112. The door frame 108 is configured for installation within a building. In examples, the door frame 108 defines an opening within a wall structure and receives the door panel 102. The door frame 108 may be constructed from wood, metal, composite materials, or combinations thereof. The door frame 108 surrounds and supports the door panel 102 when the door assembly 100 is installed within a building structure.

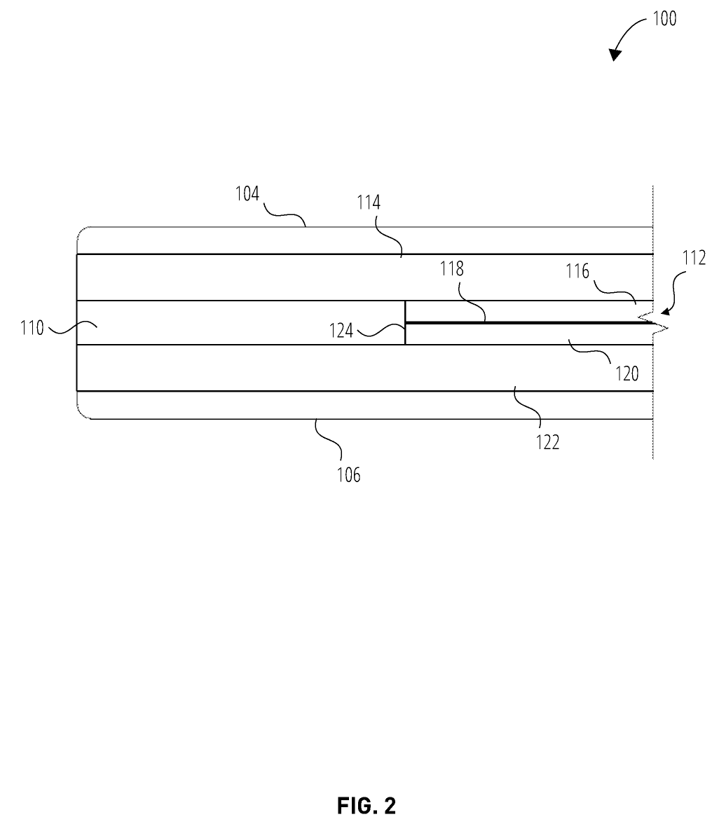

The door panel 102 couples within the door frame 108. The door panel 102 includes the front face 104 and a rear face (shown in FIG. 2). The front face 104 is directed in a first direction, and the rear face is directed in a second direction different from the first direction. In examples, the front face 104 and the rear face are oriented in opposite directions, such as toward an exterior environment and toward an interior environment of a building, respectively. The door panel 102 may be made from wood, metal, fiberglass, or combinations thereof. In examples, the door panel 102 includes a wood-based construction that permits customization of panel configurations, wood species, decorative profiles, and panel designs, including flat panels or raised panels.

The door panel 102 defines a door recess 105 (shown in FIG. 2), between the front face 104 and the rear face. The door recess provides a space within the door panel 102 for receiving the VIC 112. In examples, the door recess 105 extends through a portion of the door panel 102 or through a length of the door panel 102.

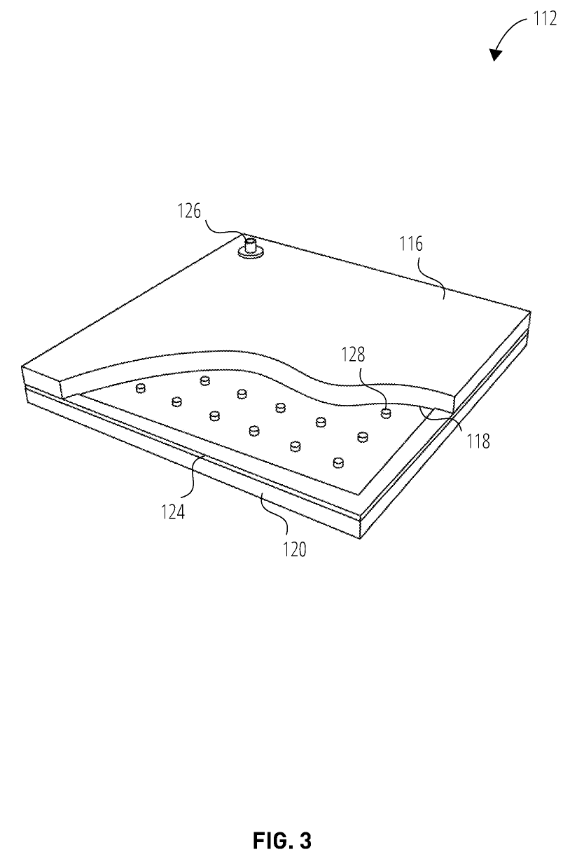

The VIC 112 is disposed within the door recess 105 and between the front face 104 and the rear face of the door panel 102. As shown in FIG. 1, the VIC 112 is represented by dashed lines to indicate that the VIC 112 is positioned within the interior of the door panel 102 and is concealed by the front face 104 when viewed from the front of the door assembly 100. The VIC 112 includes a vacuum cavity having a lower-than-ambient pressure environment and a jacket enclosing the vacuum cavity. The jacket is configured to maintain the lower-than-ambient pressure environment. The jacket includes a first jacket layer disposed within the door panel 102 adjacent to the front face 104 and a second jacket layer disposed within the door panel 102 adjacent to the rear face. The structure of the VIC 112 is described in further detail with reference to FIGS. 2 and 3.

In the example shown in FIG. 1, the VIC 112 extends through a portion of the door panel 102. In examples, the VIC 112 extends a door assembly length of the door assembly 100. In other examples, the VIC 112 extends through less than the entire length of the door assembly 100. The VIC 112 may extend at least partially through one or more components of the door panel 102, including stiles, rails, mullions, or panel portions. According to some examples, the front face 104 extends over the VIC 112 and conceals the VIC 112 from view when the door assembly 100 is observed from the front. In examples, the front face 104 includes an opaque material such that the VIC 112 is not visible through the front face 104. In examples, the door panel 102 includes one or more of insulation, a decorative layer, a wood veneer, or a customer-facing decorative layer between the jacket of the VIC 112 and the front face 104 or the rear face.

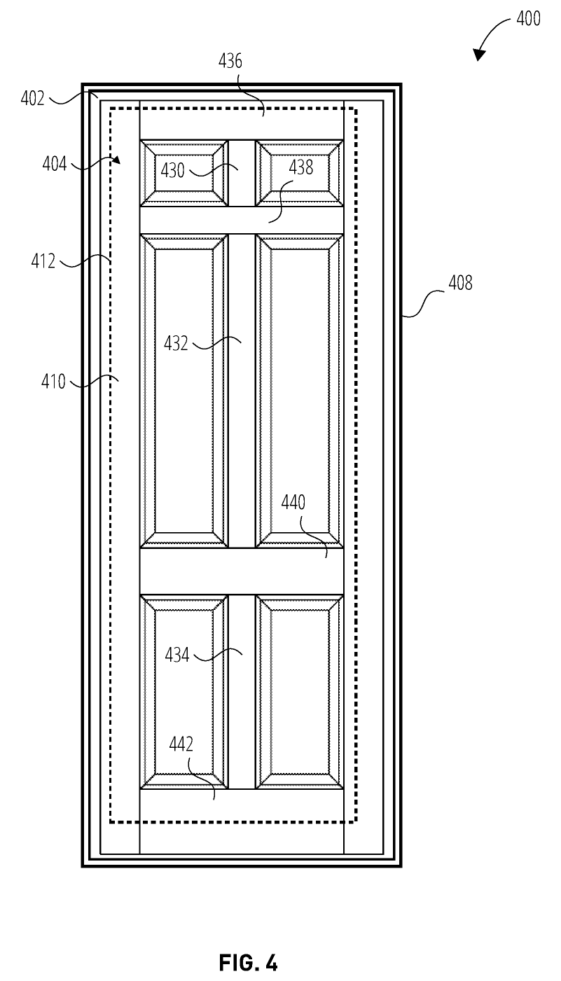

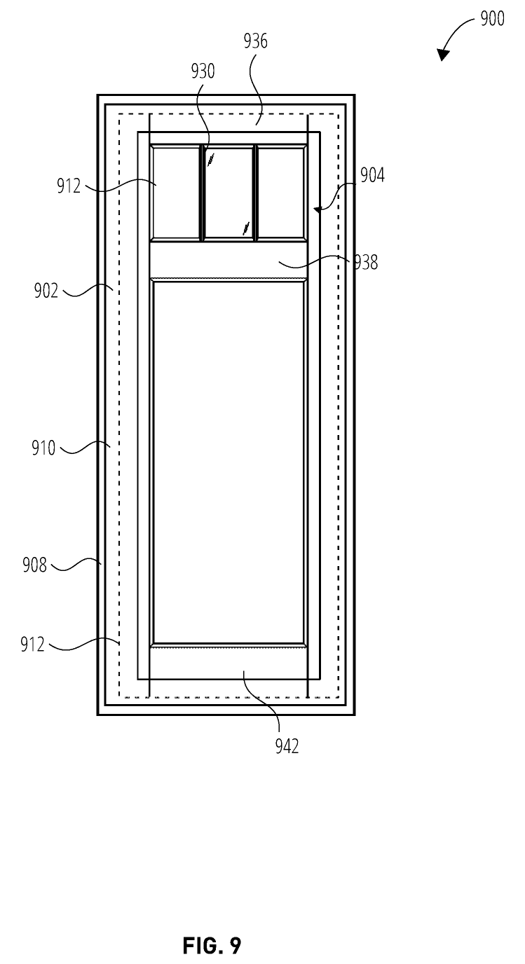

The door assembly 100 may be an entry door, a service door, or another type of exterior door. In examples, the door assembly 100 provides thermal insulation while permitting customization of the door panel 102 with different panel types, panel configurations, wood species, sticking profiles, flat panels, raised panels, or combinations thereof. The door assembly 100 will be discussed in more detail herein with reference to FIGS. 2–3. Other examples of the door assembly, e.g., the door assembly 400 (discussed in FIGS. 4–8), and the door assembly 900 (discussed in FIGS. 9–12) are also discussed herein. The inventors of the present disclosure contemplate that the discussions related to any one of the door assemblies can be applied to the other door assemblies.

FIG. 2 illustrates a cross-sectional view of a portion of the door assembly 100 of FIG. 1. The cross-section is taken through the door panel 102 and depicts the internal structure of the VIC 112. FIG. 2 shows the front face 104, a rear face 106, a stile 110, the VIC 112, a first insulation layer 114, a first jacket layer 116, a vacuum cavity 118, a second jacket layer 120, a second insulation layer 122, and an edge seal 124.

The rear face 106 is shown opposite the front face 104. The rear face 106 directs in a second direction different from the first direction of the front face 104. The door recess or cavity, e.g., the door recess 105, extends between the front face 104 and the rear face 106 and receives the VIC 112.

The stile 110 forms a vertical member of the door panel 102 and extends along a side of the door panel 102. As shown in FIG. 2, the VIC 112 extends into the stile 110. The extent to which the VIC 112 extends into the stile 110 may be adjusted based on the location of hardware, such as hinges, locks, or other components that require fastener penetration into the stile 110. By extending the VIC only partially into the stile 110, a solid wood region is preserved for secure hardware mounting while maximizing insulative coverage in the door panel. In examples, the VIC 112 only extends between the stile 110 and may not extend into the stiles 110. The VIC 112 includes the vacuum cavity 118, the first jacket layer 116, the second jacket layer 120, and the edge seal 124, according to some examples.

The first jacket layer 116 is disposed within the door panel 102 toward the front face 104. The first jacket layer 116 is positioned within the door recess 105 and adjacent the front face 104. The first jacket layer 116 may be made of glass, ceramic, foam, rubber, or metal. In examples, the first jacket layer 116 includes glass. In examples, the first jacket layer 116 includes an opaque material.

The vacuum cavity 118 is enclosed between the first jacket layer 116 and the second jacket layer 120. The vacuum cavity 118 contains a lower-than-ambient-pressure environment. In examples, lower-than-ambient-pressure includes less than 10.0 Pa. In examples, lower-than-ambient-pressure includes less than 1.0 Pa. In examples, lower-than-ambient-pressure includes between 0.1 Pa and 1.0 Pa. In examples, lower-than-ambient-pressure includes less than .1 Pa. In examples, the vacuum cavity 118 has a thickness of approximately 0.008 to 0.010 inches (approximately 0.2 to 0.25 millimeters).

The second jacket layer 120 is disposed within the door panel 102 between the vacuum cavity 118 and the rear face 106. The second jacket layer 120 is positioned within the door recess 105 and toward the rear face 106 relative to the first jacket layer 116. The second jacket layer 120 may be made of glass, ceramic, foam, rubber, or metal. In examples, the second jacket layer 120 includes glass. In examples, the second jacket layer 120 includes an opaque material.

The first jacket layer 116 and the second jacket layer 120 define the vacuum cavity 118. The vacuum cavity 118 is between the first jacket layer 116 and the second jacket layer 120. The edge seal 124 extends between the first jacket layer 116 and the second jacket layer 120. The edge seal 124 is interposed between the first jacket layer 116 and the second jacket layer 120 at a perimeter of the vacuum cavity 118. The first jacket layer 116, the second jacket layer 120, and the edge seal 124 together encompass the vacuum cavity 118 and maintain the lower-than-ambient-pressure environment. The edge seal 124 includes at least one of ceramic or metal. In examples, the edge seal 124 includes a ceramic frit material. In examples, the edge seal 124 includes a ceramic frit material fused to the first jacket layer 116 and the second jacket layer 120.

The first insulation layer 114 is disposed between the first jacket layer 116 and the front face 104. The first insulation layer 114 may be made from at least one of foam, ceramic, or rubber. In examples, the first insulation layer 114 includes or is replaced by a decorative layer, a wood veneer, or a customer-facing decorative layer.

The second insulation layer 122 is disposed between the second jacket layer 120 and the rear face 106. The second insulation layer 122 may be made from at least one of foam, ceramic, or rubber. In examples, the second insulation layer 122 includes or is replaced by a decorative layer, a wood veneer, or a customer-facing decorative layer.

In examples, the first insulation layer 114 and the second insulation layer 122 are omitted, and the first jacket layer 116 is disposed directly adjacent the front face 104 and the second jacket layer 120 is disposed directly adjacent the rear face 106. The inclusion of insulation layers, e.g., the first insulation layer 114 or the second insulation layer 122, may be determined based on target thermal performance, door thickness constraints, and manufacturing considerations. In examples, insulation layers supplement the thermal performance of the VIC 112. In other examples, jacket layers, e.g., the first jacket layer 116 and the second jacket layer 120, are disposed directly adjacent to the front and rear faces without intervening insulation layers.

FIG. 3 illustrates a perspective cutaway view of the VIC 112. The cutaway view depicts the first jacket layer 116 partially removed to reveal internal components of the VIC 112. FIG. 3 shows the first jacket layer 116, the vacuum cavity 118, the second jacket layer 120, the edge seal 124, a draw tube 126, and support pillars 128.

The draw tube 126 extends through the first jacket layer 116. The draw tube 126 provides a passage for evacuating gas from between the first jacket layer 116 and the second jacket layer 120 during manufacture of the VIC 112. The draw tube 126 permits reduction of pressure within the vacuum cavity 118 to establish a lower-than-ambient-pressure environment. After evacuation, the draw tube 126 is sealed to maintain the vacuum within the vacuum cavity 118. In examples, the draw tube 126 is positioned near a corner or edge of the VIC 112. In examples, the draw tube 126 extends through the second jacket layer 120 instead of the first jacket layer 116.

The support pillars 128 are disposed between the first jacket layer 116 and the second jacket layer 120. The support pillars 128 are distributed across the vacuum cavity 118. The support pillars 128 are configured to maintain the separation between the first jacket layer 116 and the second jacket layer 120. The lower-than-ambient pressure environment within the vacuum cavity 118 exerts a compressive force on the first jacket layer 116 and the second jacket layer 120. The support pillars 128 resist this compressive force and maintain the vacuum cavity 118 at a specified thickness.

In examples, the support pillars 128 include non-opaque support pillars. In examples, the support pillars 128 have a diameter approximately equal to their height. In examples, the support pillars 128 have a diameter of approximately 0.010 inches (about 0.25 millimeters). The support pillars 128 may be visible under certain lighting conditions, such as when the VIC 112 is viewed against a uniform background. The support pillars 128 may not be visible when the VIC 112 is viewed against a non-uniform background.

The quantity and distribution of the support pillars 128 may vary based on the thickness of the first jacket layer 116 and the second jacket layer 120. Thinner jacket layers may include more support pillars 128 to maintain separation. Thicker jacket layers may include fewer support pillars 128. The selection of the thickness of the jacket layers, e.g., the first jacket layer 116 and the second jacket layer 120, and the quantity of support pillars, e.g., the support pillars 128, may be based on factors including cost, thermal performance, and manufacturability.

In examples, the support pillars 128 are arranged in a grid pattern across the vacuum cavity 118. In examples, the support pillars 128 are arranged in a staggered pattern. The spacing between adjacent support pillars 128 may be uniform or may vary across the VIC 112, for instance with more or less pillars 128 provided proximate a perimeter of the VIC 112, less pillars 128 in a translucent portion of the VIC 112, or vice versa.

FIG. 4 illustrates a front view of another example door assembly 400 having one or more vacuum-insulated cores. The door assembly 400 includes a door panel 402, a front face 404, a door frame 408, stiles 410, a VIC 412, a top mullion 430, a mid mullion 432, a lower mullion 434, a top rail 436, a Frieze rail 438, a middle rail 440, and a bottom rail 442.

The door assembly 400 depicts a multi-panel door configuration. The door panel 402 includes a raised-panel design that has multiple panel sections encompassed by the rails and mullions. The front face 404 is visible in FIG. 4 and includes contoured surfaces corresponding to the raised-panel design. The door frame 408 surrounds the door panel 402. The door panel 402 rotatably couples to the door frame 408. The stiles 410 form vertical members of the door panel 402. In examples, a first stile 410 extends along a first side of the door panel 402, and a second stile 410 extends along a second side of the door panel 402 opposite the first side. The stiles 410 extend from the top rail 436 to the bottom rail 442.

According to examples, the top rail 436 is included in the top of the door panel 402 and extends horizontally between the stiles 410. The bottom rail 442 is disposed at the bottom of the door panel 402 and extends horizontally between the stiles 410. The Frieze rail 438 extends horizontally between the stiles 410 and is positioned below the top rail 436. The middle rail 440 extends horizontally between the stiles 410 and is positioned between the Frieze rail 438 and the bottom rail 442. The rails provide structural support to the door panel 402. The top mullion 430 extends vertically between the top rail 436 and the Frieze rail 438. The mid mullion 432 extends vertically between the Frieze rail 438 and the middle rail 440. The lower mullion 434 extends vertically between the middle rail 440 and the bottom rail 442. The mullions divide the door panel 402 into panel sections.

The VIC 412 is disposed within the door panel 402 between the front face 404 and a rear face. In FIG. 4, the VIC 412 is represented by dashed lines to indicate that the VIC 412 is positioned within the interior of the door panel 402 and is concealed by the front face 404. The VIC 412 extends through the door panel 402 at least partially through one or more of the rails, mullions, or stiles 410. In the examples, the VIC 412 comprises a plurality of vacuum-insulated cores, each corresponding to a different component of the door assembly 400. The different components include one or more of the stiles 410, the rails (top rail 436, Frieze rail 438, middle rail 440, bottom rail 442), the panel sections, or the mullions (top mullion 430, mid mullion 432, lower mullion 434). In examples, a first VIC is disposed within a stile 410, a second VIC is disposed within a panel section, and a third VIC is disposed within a mullion.

In examples, multiple VICs are layered between the front face 404 and the rear face. In examples, a single monolithic VIC extends through the door panel 402 across multiple components, including the stiles 410, rails, mullions, and panel sections. The extent to which the VIC 412 extends into the stiles 410 may be adjusted based on hardware locations. The VIC 412 may extend deeper into the top rail 436 and the bottom rail 442 than into the stiles 410 to accommodate hinges, locks, or other hardware mounted to the stiles 410. The door assembly 400, including the VIC 412 within the door panel 402, may be selected based on a target thermal insulation value and manufacturability. A monolithic example of the VIC 412 spanning the entire door panel 402 may provide higher thermal insulation than multiple separate VICs for individual components.

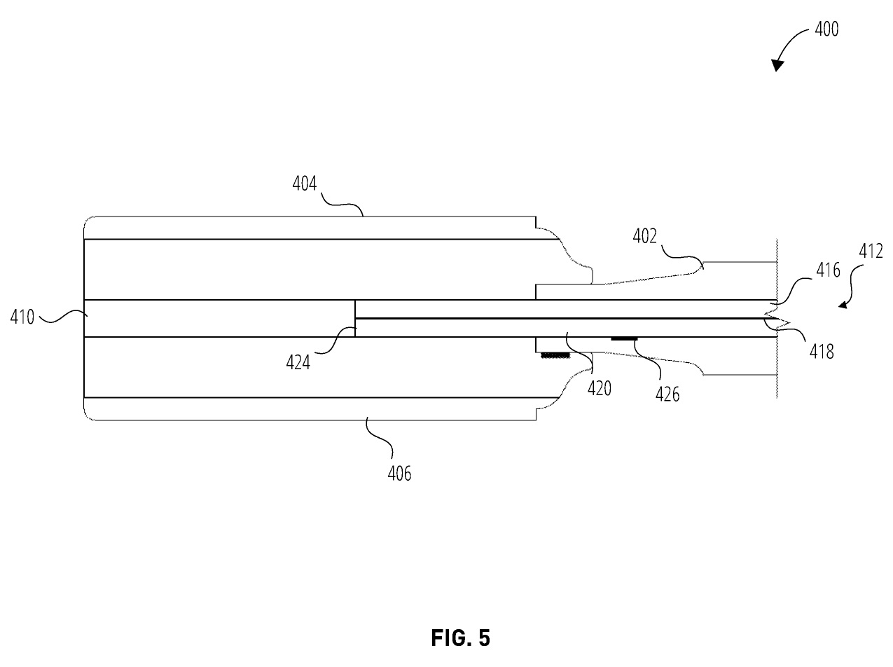

FIG. 5 illustrates a cross-sectional view of a door interior example for the door assembly 400 of FIG. 4. FIG. 5 shows the door assembly 400, the door panel 402, the front face 404, a rear face 406, the stile 410, the VIC 412, a first jacket layer 416, a vacuum cavity 418, a second jacket layer 420, an edge seal 424, and a draw tube 426.

The rear face 406 is positioned opposite the front face 404. The cross-section of FIG. 5 is taken through a raised panel portion of the door panel 402 and extends into the stile 410.

The VIC 412 is disposed between the front face 404 and the rear face 406. In the configuration shown in FIG. 5, the first jacket layer 416 is disposed directly adjacent to the front face 404 without an intervening insulation layer. The second jacket layer 420 is disposed directly adjacent to the rear face 406 without an intervening insulation layer. The vacuum cavity 418 is enclosed between the first jacket layer 416 and the second jacket layer 420. The edge seal 424 extends between the first jacket layer 416 and the second jacket layer 420 at the perimeter of the vacuum cavity 418.

The draw tube 426 extends through the second jacket layer 420. In other examples, the draw tube 426 extends through the first jacket layer 416 or an edge seal.

The VIC 412 extends from the raised panel portion of the door panel 402 into the stile 410. As shown in FIG. 5, the VIC 412 extends only partially into the stile 410. The stile 410 includes a solid portion beyond the extent of the VIC 412. The solid portion accommodates hardware such as hinges or locks.

The front face 404 and the rear face 406 include contoured surfaces corresponding to the raised panel design of the door panel 402. The VIC 412 conforms to or is positioned within the contoured surfaces.

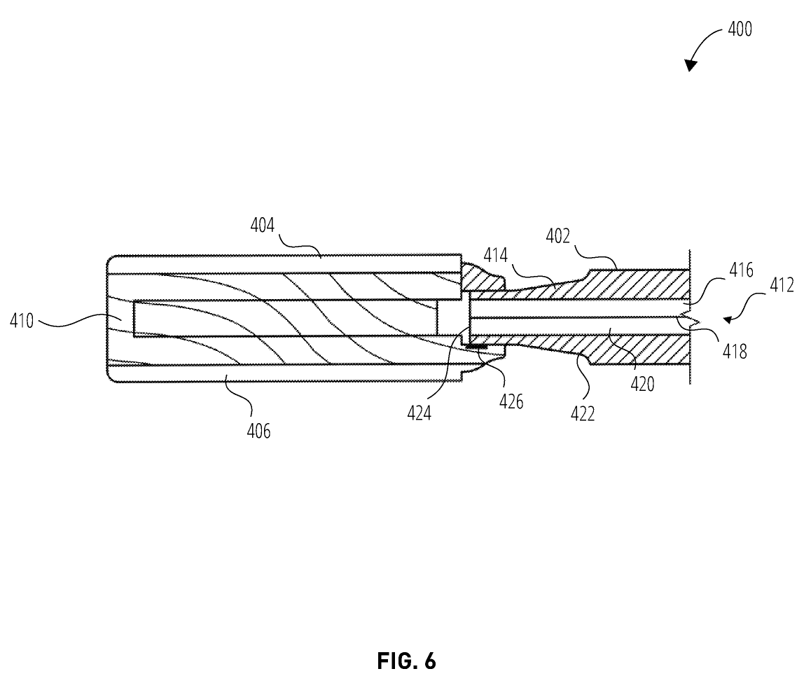

FIG. 6 illustrates a cross-sectional view of another door interior example for the door assembly 400 of FIG. 4. The example of the door assembly 400 shown in FIG. 6 includes the first insulation layer 414 and the second insulation layer 422.

The first insulation layer 414 is disposed between the first jacket layer 416 and the front face 404. The second insulation layer 422 is disposed between the second jacket layer 420 and the rear face 406. The first insulation layer 414 and the second insulation layer 422 are represented by cross-hatched regions in FIG. 6. The first insulation layer 414 and the second insulation layer 422 provide thermal insulation between the VIC 412 and the front face 404 and rear face 406, respectively. The first insulation layer 414 and the second insulation layer 422 supplement the thermal performance of the VIC 412.

In the raised panel portion of the door panel 402, the first insulation layer 414 extends between the first jacket layer 416 and the contoured surface of the front face 404. The second insulation layer 422 extends between the second jacket layer 420 and the contoured surface of the rear face 406. The first insulation layer 414 and the second insulation layer 422 conform to or fill the space formed by the raised panel contours.

In the stile 410 region, the first insulation layer 414 and the second insulation layer 422 extend between the respective jacket layers and the stile 410 material. The VIC 412 extends partially into the stile 410 with the first insulation layer 414 and the second insulation layer 422 interposed between the jacket layers and the stile 410.

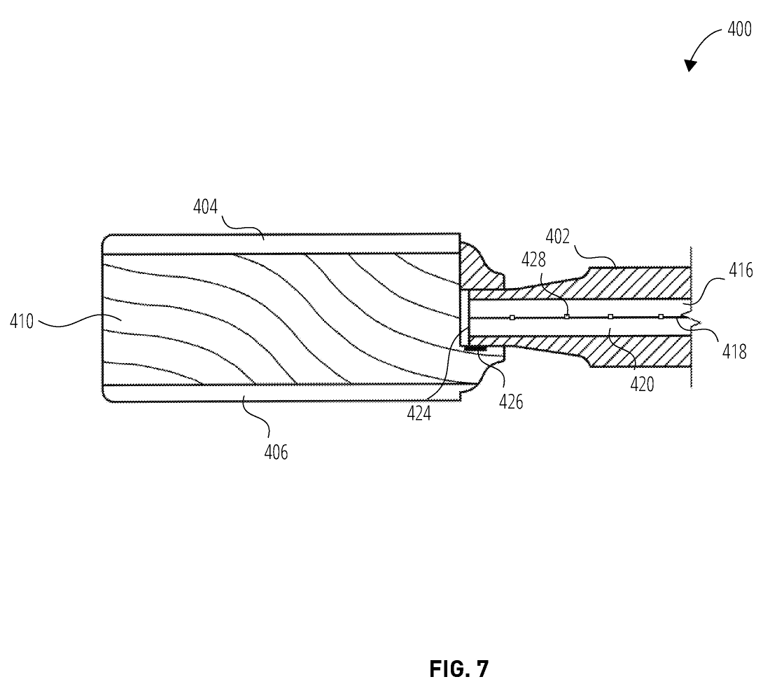

FIG. 7 illustrates a cross-sectional view of another door interior example for the door assembly 400 of FIG. 4. FIG. 7 shows the door assembly 400, the door panel 402, the front face 404, the rear face 406, the stile 410, the first jacket layer 416, the vacuum cavity 418, the second jacket layer 420, the edge seal 424, the draw tube 426, and support pillars 428.

The configuration of FIG. 7 depicts the support pillars 428 within the vacuum cavity 418. The support pillars 428 are disposed between the first jacket layer 416 and the second jacket layer 420. The support pillars 428 in various examples brace the first and second jacket layers 416, 420 and thereby maintain the separation between the first jacket layer 416 and the second jacket layer 420.

FIG. 7 depicts the front face 404, the rear face 406, and the stile 410 with a wood grain pattern. The wood grain pattern indicates that the door panel 402 includes wood in this example. The front face 404 and the rear face 406 include contoured surfaces corresponding to a raised-panel design. The cross-section of FIG. 7 is taken at a location where the VIC 412 at least partially extends into the stile 410. The first jacket layer 416 and the second jacket layer 420 terminate within the stile 410. The stile 410 extends beyond the termination of the jacket layers to accommodate hardware.

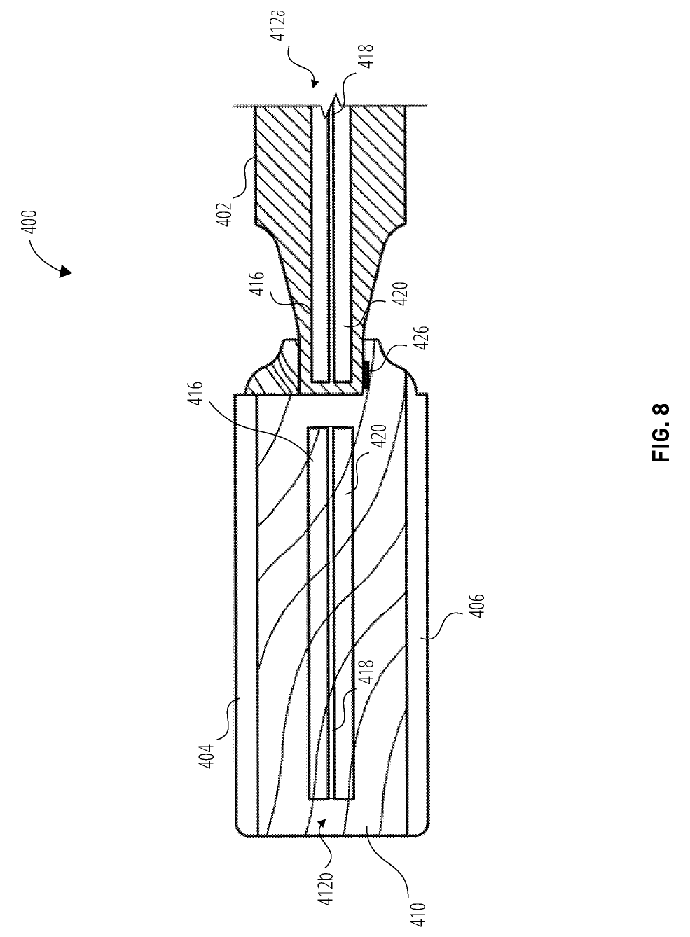

FIG. 8 illustrates a cross-sectional view of another door interior example for the door assembly 400 of FIG. 4. FIG. 8 shows the door assembly 400, the door panel 402, the front face 404, the rear face 406, the stile 410, a first VIC 412a, a second VIC 412b, the first jacket layer 416, the vacuum cavity 418, and the second jacket layer 420.

The example of the door assembly 400 (as illustrated in FIG. 8) includes multiple VICs 412 layered between the front face 404 and the rear face 406. The first VIC 412a is disposed adjacent to the front face 404. The second VIC 412b is disposed between the first VIC 412a and the rear face 406. The first VIC 412a includes a first jacket layer 416 disposed adjacent to the front face 404, a second jacket layer 420 disposed toward the rear face 406 relative to the first jacket layer 416, and a vacuum cavity 418 enclosed between the first jacket layer 416 and the second jacket layer 420 of the first VIC 412a. The second VIC 412b includes a first jacket layer 416 disposed adjacent to the second jacket layer 420 of the first VIC 412a, a second jacket layer 420 disposed adjacent to the rear face 406, and a vacuum cavity 418 enclosed between the first jacket layer 416 and the second jacket layer 420 of the second VIC 412b.

As shown in FIG. 8, in some examples, the second VIC 412b is nested within the door panel 402 between the first VIC 412a and the rear face 406. The first VIC 412a and the second VIC 412b together provide four jacket layers between the front face 404 and the rear face 406. The layered configuration provides greater thermal insulation than a single-VIC configuration. The first VIC 412a extends only partially into the stile 410. The second VIC 412b extends through the stile 410 toward the center of the door panel 402. In examples, the first VIC 412a and the second VIC 412b extend to different depths within the stile 410. In examples, the first VIC 412a and the second VIC 412b extend to the same depth within the stile 410.

FIG. 9 illustrates a front view of an additional example door assembly 900 having one or more vacuum-insulated cores. The door assembly 900 includes a door panel 902, a front face 904, a door frame 908, stiles 910, a VIC 912, a top mullion 930, a top rail 936, a Frieze 938, a bottom rail 942, and a window port 944. According to the example illustrated in FIG. 9, the window port 944 is enclosed by the top rail 936, the Frieze 938, and the top mullion 930 in an upper portion of the door panel 902. The window port 944 extends through both the front face 904 and the rear face 906. The window port 944 is filled by a portion of the VIC 912. The VIC 912 is visible through the window port, as the door panel 902 does not extend over this portion of the VIC 912.

The VIC 912 extends through the door panel 902. In the upper portion of the door panel 902, the VIC 912 is exposed through the window port 944. In the lower portion of the door panel 902, the VIC 912 is concealed by the front face 904. The opaqueness of the VIC 912 within the door panel 902 varies. In the example shown in FIG. 9, an upper portion of the VIC 912 is not opaque (e.g., is translucent, transparent, or the like), and a lower portion of the VIC 912 is opaque. The non-opaque upper portion of the VIC 912 corresponds to the window port 944 and permits light transmission through the door assembly 900. The opaque lower portion of the VIC 912 is concealed by the front face 904. In examples, the ratio of opaque to non-opaque portions of the VIC 912 may be approximately one-third non-opaque to two-thirds opaque, though this ratio may be adjusted based on the window port 944 size and the door panel configuration. The opaque portion may be achieved through opaque jacket layers, coatings, or films applied to the jacket layers.

In examples, the entirety of the VIC 912 is opaque. In examples, the entirety of the VIC 912 is not opaque. In examples, approximately one-third of the VIC 912 is not opaque, and approximately two-thirds of the VIC 912 is opaque. The ratio of opaque to non-opaque portions may be adjusted based on the window port 944 size and door panel configuration. Alternatively, the entire VIC 912 is non-opaque while a portion of the VIC 912 is actually within view.

The top mullion 930 extends vertically between the top rail 936 and the Frieze 938. The top mullion 930 is positioned within the window port 944 region of the door panel 902. In FIG. 9, two top mullions 930 are shown dividing the window port 944 into three sections. The stiles 910 extend vertically along opposite sides of the door panel 902. The VIC 912 extends at least partially into the stiles 910 in the lower portion of the door panel 902, where the VIC 912 is opaque.

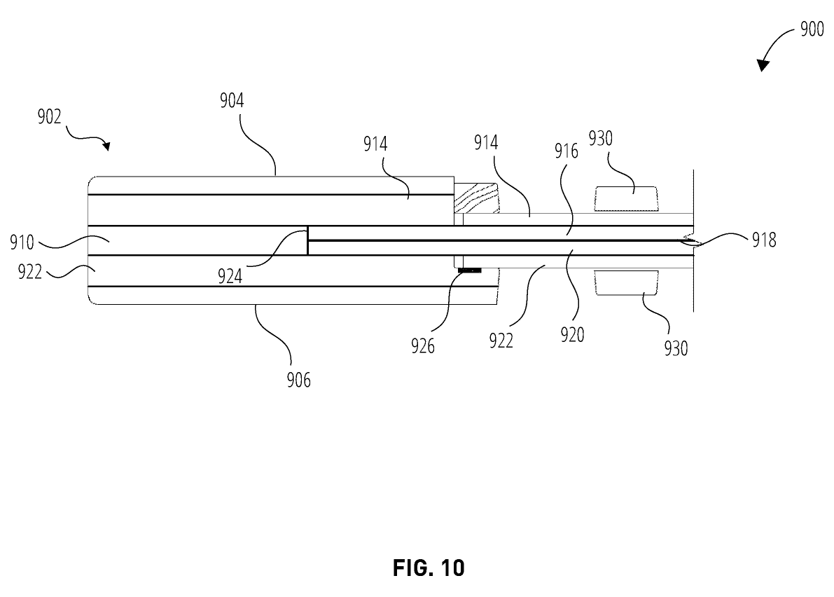

FIG. 10 illustrates a cross-sectional view of a door interior example for the door assembly 900 of FIG. 9. FIG. 10 shows the door assembly 900, the door panel 902, the front face 904, a rear face 906, the stile 910, a first insulation layer 914, a first jacket layer 916, a vacuum cavity 918, a second jacket layer 920, a second insulation layer 922, an edge seal 924, and a draw tube 926. The cross-section of FIG. 10 is taken through the window port 944 region of the door assembly 900. In the window port 944 region, the VIC 912 is exposed and not covered by the front face 904 or the rear face 906. The first jacket layer 916 and the second jacket layer 920 extend beyond the front face 904 and the rear face 906, respectively, in the window port 944 region.

In the stile 910 region, the first insulation layer 914 is disposed between the first jacket layer 916 and the front face 904. The second insulation layer 922 is disposed between the second jacket layer 920 and the rear face 906. The vacuum cavity 918 is enclosed between the first jacket layer 916 and the second jacket layer 920. The edge seal 924 extends between the first jacket layer 916 and the second jacket layer 920. The draw tube 926 is positioned within the stile 910 region where the VIC 912 is concealed by the door panel 902.

The transition between the window port 944 region and the stile 910 region is shown in FIG. 10. In the window port 944 (FIG. 9), the first jacket layer 916 and the second jacket layer 920 are spaced apart without the front face 904 and the rear face 906 extending over them. In the stile 910 region, the front face 904 and the rear face 906 extend over the first jacket layer 916 and the second jacket layer 920, respectively, with the first insulation layer 914 and the second insulation layer 922 interposed therebetween.

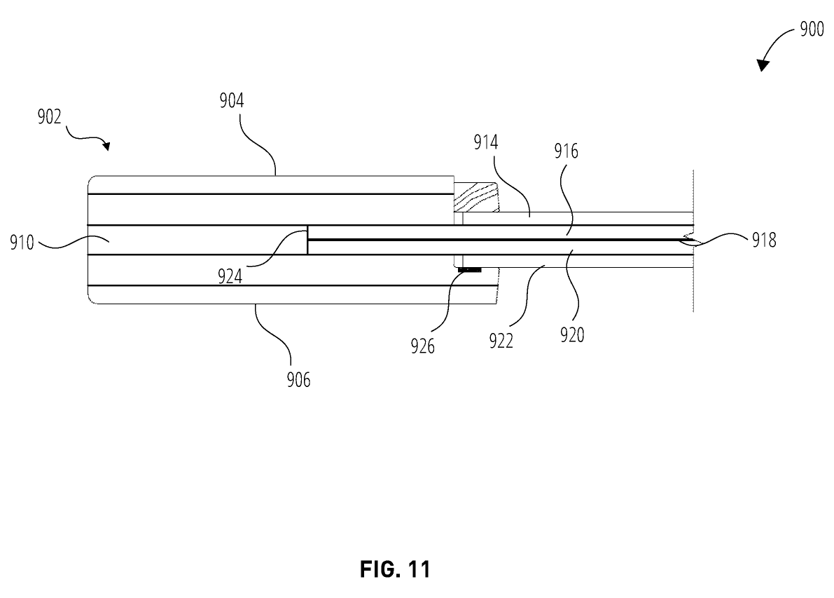

FIG. 11 illustrates a cross-sectional view of another door interior example for the door assembly 900 of FIG. 9. FIG. 11 shows the door assembly 900, the door panel 902, the front face 904, the rear face 906, the stile 910, the first insulation layer 914, the first jacket layer 916, the vacuum cavity 918, the second jacket layer 920, the second insulation layer 922, the edge seal 924, and the draw tube 926. The cross-section of FIG. 11 is taken through the opaque portion of the door assembly 900, below the window port 944 region shown in FIG. 9. In this cross-section, the front face 904 and the rear face 906 extend over the VIC 912 across the width of the door panel 902.

In the example illustrated in FIG. 11, the VIC 912 is concealed by the front face 904 and the rear face 906 throughout the cross-section. The first jacket layer 916 and the second jacket layer 920 do not extend beyond the front face 904 and the rear face 906 in this region. The first insulation layer 914 extends between the first jacket layer 916 and the front face 904 across the panel region and into the stile 910 region. The second insulation layer 922 extends between the second jacket layer 920 and the rear face 906 across the panel region and into the stile 910 region.

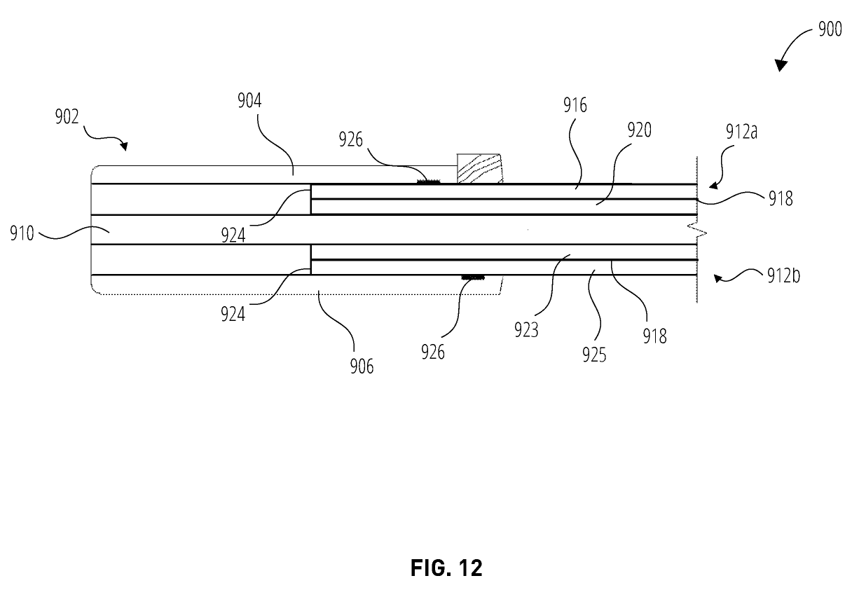

FIG. 12 illustrates a cross-sectional view of an additional door interior example for the door assembly 900 of FIG. 9. FIG. 12 shows the door assembly 900, the door panel 902, the front face 904, the rear face 906, the stile 910, edge seals 924, draw tubes 926, a first VIC 912a, and a second VIC 912b. In the example illustrated in FIG. 12, the door assembly 900 includes a layered VIC arrangement in which the first VIC 912a and the second VIC 912b are stacked between the front face 904 and the rear face 906, providing four jacket layers and two vacuum cavities for enhanced thermal insulation. In examples, the first VIC 912aand the second VIC 912b can be directly stacked with no intervening components and sealed with an edge seal 924, resulting in three vacuum cavities. In examples, the first VIC 912a and the second VIC 912b can be separated by an insulation layer or another component of the door assembly 900.

In examples, the first VIC 912a and the second VIC 912b can be nested between the front face 904 and the 906. For example, the second VIC 912b can be disposed within the first VIC 912a, or the first VIC 912a can be disposed within the second VIC 912b. In such an example, there can be three vacuum cavities 918 (a first vacuum cavity 918 between the first jacket layer 916 and the third jacket layer 923, a second vacuum cavity 918 between the third jacket layer 923 and the fourth jacket layer 925, and a third vacuum cavity 918 between the fourth jacket layer 925 and the second jacket layer 920). As such, the nested VICs can provide better thermal performance than a stacked version with only two vacuum cavities.

The first VIC 912a includes a first jacket layer 916 disposed adjacent the front face 904 and a second jacket layer 920 spaced from the first jacket layer 916. A vacuum cavity 918 is enclosed between the first jacket layer 916 and the second jacket layer 920. An edge seal 924 extends between the first jacket layer 916 and the second jacket layer 920 to maintain the vacuum cavity 918. A draw tube 926 is associated with the first VIC 912a to permit evacuation of the vacuum cavity 918 during manufacture.

The second VIC 912b includes a third jacket layer 923 disposed adjacent the second jacket layer 920 of the first VIC 912a and a fourth jacket layer 925 disposed adjacent the rear face 906. A vacuum cavity 918 is enclosed between the third jacket layer 923 and the fourth jacket layer 925. An edge seal 924 extends between the third jacket layer 923 and the fourth jacket layer 925 to maintain the vacuum cavity 918. A draw tube 926 is associated with the second VIC 912b.

The layered example of the door assembly 900 (as illustrated in FIG. 12) provides four jacket layers between the front face 904 and the rear face 906: the first jacket layer 916 (adjacent the front face 904), the second jacket layer 920, the third jacket layer 923 (adjacent the second jacket layer 920), and the fourth jacket layer 925 (adjacent the rear face 906). The two separate vacuum cavities 918 of the first VIC 912a and the second VIC 912b provide greater thermal insulation than a single vacuum cavity configuration. In the stile 910 region, a first insulation layer 914 is disposed between the first jacket layer 916 and the front face 904, and a second insulation layer 922 is disposed between the fourth jacket layer 925 and the rear face 906. The first VIC 912a and the second VIC 912b extend at least partially into the stile 910.

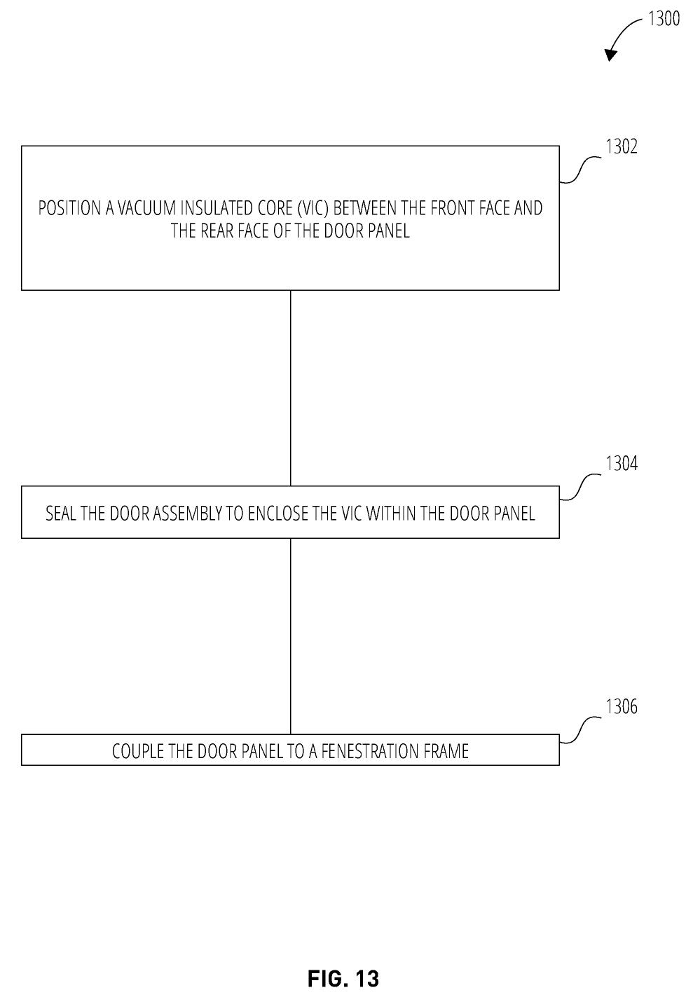

FIG. 13 illustrates a block diagram of an example method 1300 of assembling a door assembly. The method 1300 may be used to assemble any of the door assemblies 100, 400, 900 described with reference to FIGS. 1-12. Although FIG. 13 depicts a particular sequence of operations, the sequence may be altered without departing from the scope of the present disclosure. In examples, some of the operations depicted may be performed in parallel or in a different sequence.

At operation 1302, the method 1300 positions a vacuum-insulated core (VIC) between the front face and the rear face of the door panel. The VIC includes a vacuum cavity disposed between a first jacket layer and a second jacket layer. The method 1300 inserts the VIC between the front face and the rear face such that the first jacket layer is disposed adjacent the front face and the second jacket layer is disposed adjacent the rear face. In some examples, the VIC may be inserted between the front face and the rear face such that the first jacket layer is adjacent a first insulation layer and the first insulation layer is disposed between the front face and the first jacket layer. Additionally, the second jacket layer may be disposed between the rear face and a second insulation layer such that the second insulation layer is adjacent the rear face.

In examples, at operation 1302, the method 1300 may include positioning the VIC within a door recess, e.g., the door recess 105, defined between the front face and the rear face. The door recess receives the VIC and accommodates the first jacket layer, the second jacket layer, and the vacuum cavity therebetween. For example, the method 1300 may include positioning a single VIC between the front face and the rear face, as shown in FIGS. 2, 5, 6, 7, 10 and 11. In other examples, the method 1300 includes positioning multiple VICs between the front face and the rear face, as shown in FIGS. 8 and 12. The VIC extends at least partially into one or more components of the door panel, including stiles, rails, mullions, or panel portions. In examples, the VIC extends a door assembly length of the door assembly. As shown in the examples illustrated in FIG. 9 and FIG. 10, a portion of the VIC fills a window port, e.g., the window port 944, defined in the front face and the rear face.

At operation 1304, the method 1300 may optionally include sealing the door assembly to enclose the VIC within the door panel. In examples, sealing the door assembly includes attaching the front face to the rear face with the VIC disposed therebetween. In examples, sealing the door assembly includes fully enclosing the VIC with the components of the door panel such that the VIC is concealed from view. In some examples, the VIC is partially enclosed and partially exposed. The partially exposed portion of the VIC may fill a window port defined in the front face and the rear face.

At operation 1304, the method 1300 may optionally include disposing one or more insulation layers between the jacket layers of the VIC and the front face or the rear face. The insulation layers may include foam, ceramic, or rubber. In examples, one or more of a decorative layer, a wood veneer, or a customer-facing decorative layer are disposed between the jacket and the front face or the rear face.

At operation 1306, the method 1300 may include coupling the door panel to a fenestration frame. The fenestration frame may include the door frames 108, 408, 908 described with reference to FIGS. 1, 4 and 9. Coupling the door panel to the fenestration frame completes the assembly of the door assembly. In examples, the door panel may be coupled to the fenestration frame using hinges, fasteners, or other coupling mechanisms. The door panels may be made from, or may include, wood, metal, fiberglass, or combinations thereof. In examples, at least one of the front face or the rear face includes wood. Wood-based door panels permit customization of panel configurations, wood species, decorative profiles, and panel designs.

In examples, one or both of the first jacket layer and the second jacket layer include an opaque jacket layer. In examples, one or both of the first jacket layer and the second jacket layer include a non-opaque jacket layer.

The following, non-limiting examples, detail certain aspects of the present subject matter to solve the challenges and provide the benefits discussed herein, among others.

Example 1 is a door assembly comprising: a door frame configured for installation within a building; a door panel coupled within the door frame, the door panel includes: a front face directed in a first direction; a rear face directed in a second direction, the second direction different from the first direction; and a door recess between the front face and the rear face; and a vacuum insulated core (VIC) within the door recess and between the front face and the rear face of the door panel, the VIC includes: a vacuum cavity having a lower than ambient pressure environment; and a jacket enclosing the vacuum cavity, the jacket configured to maintain the lower than ambient pressure environment, the jacket includes: a first jacket layer disposed within the door panel adjacent to the front face; and a second jacket layer disposed within the door panel adjacent to the rear face.

In Example 2, the subject matter of Example 1 optionally includes wherein the VIC extends the length of the door assembly.

In Example 3, the subject matter of any one or more of Examples 1–2 optionally includes wherein the first jacket layer and the second jacket layer include a separation defined therebetween.

In Example 4, the subject matter of any one or more of Examples 1–3 optionally includes wherein the VIC comprises: an edge seal interposed between the first jacket layer and the second jacket layer, and wherein the first jacket layer, the second jacket layer, and the edge seal encompass the vacuum cavity to maintain the lower than ambient pressure environment.

In Example 5, the subject matter of Example 4 optionally includes wherein the edge seal includes at least one of ceramic or metal.

In Example 6, the subject matter of any one or more of Examples 4–5 optionally includes wherein the first jacket layer and the second jacket layer include metal or ceramic.

In Example 7, the subject matter of any one or more of Examples 1–6 optionally includes wherein the jacket includes an opaque jacket.

In Example 8, the subject matter of any one or more of Examples 4–7 optionally includes wherein the first jacket layer and the second jacket layer include glass.

In Example 9, the subject matter of any one or more of Examples 3–8 optionally includes wherein the VIC comprises: a spacing support disposed between the first jacket layer and the second jacket layer, the support configured to maintain the separation defined between the first jacket layer and the second jacket layer.

In Example 10, the subject matter of any one or more of Examples 1–9 optionally includes wherein the VIC comprises a plurality of vacuum insulated cores (VICs), each vacuum insulated core of the VICs corresponding to a different component of the door assembly.

In Example 11, the subject matter of Example 10 optionally includes wherein the different component of the door assembly includes at least one of a stile, a rail, a panel, or a mullion.

In Example 12, the subject matter of any one or more of Examples 1–11 optionally includes wherein the VIC comprises a second vacuum-insulated core nested within the VIC.

In Example 13, the subject matter of any one or more of Examples 1–12 optionally includes wherein the VIC includes at least a first VIC (fVIC) and a second VIC (sVIC): the sVIC disposed between the front face and the rear face of the door panel, the sVIC includes: a second vacuum cavity; and a second jacket enclosing the vacuum cavity.

In Example 14, the subject matter of any one or more of Examples 1–13 optionally includes wherein each of the front face and the rear face of the door panel includes a window port filled by a portion of the VIC.

Example 15 is a door assembly comprising: a door frame configured for installation within a building; a door panel coupled within the door frame, the door panel includes a front face and a rear face, the front face and rear face facing opposing directions; a door recess between the front face and the rear face; and a vacuum-insulated core (VIC) within the door recess and between the front face and the rear face of the door panel, the VIC includes: a vacuum cavity having a lower-than-ambient pressure environment; a jacket enclosing the vacuum cavity; and an edge seal surrounding the vacuum cavity such that the jacket and the edge seal maintain the lower-than-ambient pressure environment of the vacuum cavity.

In Example 16, the subject matter of Example 15 optionally includes wherein the jacket includes a first jacket, and the first jacket comprises: a first jacket layer disposed within the door recess and adjacent the front face; and a second jacket layer disposed within the door recess and toward the rear face relative to the first jacket layer; and wherein the second jacket comprises: a third jacket layer disposed within the door recess and adjacent the second jacket layer; and a fourth jacket layer disposed within the door recess and adjacent the rear face.

In Example 17, the subject matter of any one or more of Examples 15–16 optionally includes wherein the jacket comprises: a first jacket layer disposed within the door recess and adjacent the front face; and a second jacket layer disposed within the door recess and toward the rear face relative to the first jacket layer.

In Example 18, the subject matter of Example 17 optionally includes a first insulation layer disposed between the first jacket layer and the front face; and a second insulation layer disposed between the second jacket layer and the rear face.

In Example 19, the subject matter of Example 18 optionally includes wherein the first insulation layer and the second insulation layer include at least one of foam, ceramic, or rubber.

In Example 20, the subject matter of any one or more of Examples 17–19 optionally includes wherein the first jacket layer and the second jacket layer include a separation defined therebetween, wherein the edge seal is interposed between the first jacket layer and the second jacket layer, and wherein the first jacket layer, the second jacket layer, and the edge seal encompass the vacuum cavity.

In Example 21, the subject matter of any one or more of Examples 1–20 optionally includes wherein the VIC comprises a plurality of vacuum-insulated cores (VICs), each vacuum-insulated core of the VICs corresponding to a different component of the door assembly.

In Example 22, the subject matter of Example 21 optionally includes wherein the different component of the door assembly includes at least one of a stile, a rail, a panel, or a mullion.

In Example 23, the subject matter of any one or more of Examples 15–22 optionally includes wherein the VIC includes at least a first VIC (fVIC) and a second vacuum-insulated core (sVIC): the sVIC disposed between the front face and the rear face of the door panel, the sVIC includes: a second vacuum cavity; and a second jacket enclosing the vacuum cavity.

In Example 24, the subject matter of Example 23 optionally includes wherein the jacket comprises: a first jacket layer disposed within the door recess and adjacent the front face; and a second jacket layer disposed within the door recess and toward the rear face relative to the first jacket layer; and wherein the second jacket comprises: a third jacket layer disposed within the door recess and adjacent the second jacket layer; and a fourth jacket layer disposed within the door recess and adjacent the rear face.

In Example 25, the subject matter of any one or more of Examples 15–24 optionally includes wherein each of the front face and the rear face includes a window port filled by a portion of the VIC.

In Example 26, the subject matter of any one or more of Examples 15–25 optionally includes wherein the door panel includes at least one of wood, metal, or fiberglass.

Example 27 is a method of assembling a door assembly, the door assembly including a door panel including a front face and a rear face, the method comprising: positioning a vacuum-insulated core (VIC) between the front face and the rear face of the door panel, the VIC includes a vacuum cavity disposed between a first jacket layer and a second jacket layer, the VIC inserted between the front face and the rear face such that the first jacket layer is disposed adjacent the front face and the second jacket layer is disposed adjacent the rear face; sealing the door assembly to enclose the VIC within the door panel; and coupling the door panel to a fenestration frame.

In Example 28, the subject matter of Example 27 optionally includes wherein at least one of the front face or the rear face includes wood.

In Example 29, the subject matter of any one or more of Examples 27–28 optionally includes wherein positioning the VIC between the front face and the rear face of the door panel includes: positioning a first vacuum-insulated core (fVIC) adjacent to the front face; and positioning a second vacuum-insulated core (sVIC) adjacent to the rear face such that the sVIC is disposed between the fVIC and the rear face.

In Example 30, the subject matter of any one or more of Examples 27–29 optionally includes wherein one or both of the first jacket layer and the second jacket layer include an opaque jacket layer.

Example 31 includes a device, system, or method including any one or more elements of any one or more of Examples 1–30.

The above detailed description includes references to the accompanying drawings, which form a part of the detailed description. The drawings illustrate specific examples that may be practiced. These embodiments are also referred to herein as “examples.” Such examples may include elements beyond those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usage between this document and the incorporated reference (s) by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. A door assembly comprising:
a door frame configured for installation within a building;
a door panel coupled within the door frame, the door panel includes:
a front face directed in a first direction;
a rear face directed in a second direction, the second direction different from the first direction; and
a door recess between the front face and the rear face; and
a vacuum insulated core (VIC) within the door recess and between the front face and the rear face of the door panel, the VIC includes:
a vacuum cavity having a lower than ambient pressure environment; and
a jacket enclosing the vacuum cavity, the jacket configured to maintain the lower than ambient pressure environment, the jacket includes:
a first jacket layer disposed within the door panel adjacent to the front face; and
a second jacket layer disposed within the door panel adjacent to the rear face.

2. The door assembly of claim 1, wherein the VIC extends a door assembly length of the door assembly.

3. The door assembly of claim 1, wherein the first jacket layer and the second jacket layer include a separation defined therebetween.

4. The door assembly of claim 1, wherein the VIC comprises:
an edge seal interposed between the first jacket layer and the second jacket layer, and wherein the first jacket layer, the second jacket layer, and the edge seal encompass the vacuum cavity to maintain the lower than ambient pressure environment.

5. The door assembly of claim 4, wherein the edge seal includes at least one of ceramic or metal.

6. The door assembly of claim 4, wherein the first jacket layer and the second jacket layer include metal or ceramic.

7. The door assembly of claim 1, wherein the jacket includes an opaque jacket.

8. The door assembly of claim 4, wherein the first jacket layer and the second jacket layer include glass.

9. The door assembly of claim 3, wherein the VIC comprises:
a spacing support disposed between the first jacket layer and the second jacket layer, the spacing support configured to maintain the separation defined between the first jacket layer and the second jacket layer.

10. The door assembly of claim 1, wherein the VIC comprises a plurality of vacuum insulated cores (VICs), each vacuum insulated core of the VICs corresponding to a different component of the door assembly.

11. The door assembly of claim 10, wherein the different component of the door assembly includes at least one of a stile, a rail, a panel, or a mullion.

12. The door assembly of claim 1, wherein the VIC comprises a second vacuum insulated core nested within the VIC.

13. The door assembly of claim 1, wherein the VIC includes at least a first VIC (fVIC) and a second VIC (sVIC):
the sVIC disposed between the front face and the rear face of the door panel, the sVIC includes:
a second vacuum cavity; and
a second jacket enclosing the second vacuum cavity.

14. The door assembly of claim 1, wherein each of the front face and the rear face of the door panel includes a window port filled by a portion of the VIC.

15. A door assembly comprising:
a door frame configured for installation within a building;
a door panel coupled within the door frame, the door panel includes a front face and a rear face, the front face and rear face facing opposing directions;
a door recess between the front face and the rear face; and
a vacuum insulated core (VIC) within the door recess and between the front face and the rear face of the door panel, the VIC includes:
a vacuum cavity having a lower than ambient pressure environment;
a jacket enclosing the vacuum cavity; and
an edge seal surrounding the vacuum cavity such that the jacket and the edge seal maintain the lower than ambient pressure environment of the vacuum cavity.

16. The door assembly of claim 15, wherein the jacket includes a first jacket, and the first jacket comprises:
a first jacket layer disposed within the door recess and adjacent the front face; and
a second jacket layer disposed within the door recess and toward the rear face relative to the first jacket layer; and
wherein the second jacket comprises:
a third jacket layer disposed within the door recess and adjacent the second jacket layer; and
a fourth jacket layer disposed within the door recess and adjacent the rear face.

17. The door assembly of claim 15, wherein the jacket comprises:
a first jacket layer disposed within the door recess and adjacent the front face; and
a second jacket layer disposed within the door recess and toward the rear face relative to the first jacket layer.

18. The door assembly of claim 17, further comprising:
a first insulation layer disposed between the first jacket layer and the front face; and
a second insulation layer disposed between the second jacket layer and the rear face.

19. The door assembly of claim 18, wherein the first insulation layer and the second insulation layer include at least one of foam, ceramic, or rubber.

20. The door assembly of claim 17, wherein the first jacket layer and the second jacket layer include a separation defined therebetween, wherein the edge seal is interposed between the first jacket layer and the second jacket layer, and wherein the first jacket layer, the second jacket layer, and the edge seal encompass the vacuum cavity.

21. The door assembly of claim 15, wherein the VIC comprises a plurality of vacuum insulated cores (VICs), each vacuum insulated core of the VICs corresponding to a different component of the door assembly.

22. The door assembly of claim 21, wherein the different component of the door assembly includes at least one of a stile, a rail, a panel, or a mullion.

23. The door assembly of claim 15, wherein the VIC includes at least a first VIC (fVIC) and a second vacuum insulated core (sVIC):
the sVIC disposed between the front face and the rear face of the door panel, the sVIC includes:
a second vacuum cavity; and
a second jacket enclosing the second vacuum cavity.

24. The door assembly of claim 23, wherein the jacket comprises:
a first jacket layer disposed within the door recess and adjacent the front face; and
a second jacket layer disposed within the door recess and toward the rear face relative to the first jacket layer; and
wherein the second jacket comprises:
a third jacket layer disposed within the door recess and adjacent the second jacket layer; and
a fourth jacket layer disposed within the door recess and adjacent the rear face.

25. The door assembly of claim 15, wherein each of the front face and the rear face includes a window port filled by a portion of the VIC.

26. The door assembly of claim 15, wherein the door panel includes at least one of wood, metal, or fiberglass.

27. A method of assembling a door assembly, the door assembly including a door panel including a front face and a rear face, the method comprising:
positioning a vacuum insulated core (VIC) between the front face and the rear face of the door panel, the VIC includes a vacuum cavity disposed between a first jacket layer and a second jacket layer, the VIC inserted between the front face and the rear face such that the first jacket layer is disposed adjacent the front face and the second jacket layer is disposed adjacent the rear face;
sealing the door assembly to enclose the VIC within the door panel; and
coupling the door panel to a fenestration frame.

28. The method of claim 27, wherein at least one of the front face or the rear face includes wood.

29. The method of claim 27, wherein positioning the VIC between the front face and the rear face of the door panel includes:
positioning a first vacuum insulated core (fVIC) adjacent to the front face; and
positioning a second vacuum-insulated core (sVIC) adjacent to the rear face such that the sVIC is disposed between the fVIC and the rear face.

30. The method of claim 27, wherein one or both of the first jacket layer and the second jacket layer include an opaque jacket layer.
